(19) United States
(12) Patent Application Publication
(10) Pub. No.: US 2021/0004187 A1
(43) Pub. Date: Jan. 7, 2021

(54) IMAGE FORMING APPARATUS, IMAGE FORMING METHOD, AND COMPUTER-READABLE RECORDING MEDIUM STORING IMAGE FORMING PROGRAM

(71) Applicant: Konica Minolta, Inc., Tokyo (JP)

(72) Inventor: Hiroaki AIZAWA, Tokyo (JP)

(73) Assignee: Konica Minolta, Inc., Tokyo (JP)

(21) Appl. No.: 16/902,500

(22) Filed: Jun. 16, 2020

(30) Foreign Application Priority Data
Jul. 2, 2019 (JP) 2019-123826

(51) Int. Cl. G06F 3/12

(52) U.S. Cl. CPC G06F 3/1258; G06F 3/1204; G06F 3/1256

(57) ABSTRACT

An image forming apparatus may be capable of preventing the occurrence of downtime and improving productivity in a configuration that enables the replacement of post-processing units. The image forming apparatus may include: a post-processing portion replaceably mounted with post-processing units that perform different post-processes on a recording medium formed with an image; a manipulation portion to enter a new job setting including a selection of a post-process performed on the post-processing portion; and a controller to control the post-processing portion and the manipulation portion. The controller may include: a storage portion that stores identification information about a post-processing unit mountable on the post-processing portion; and an input/output controller capable of selecting a post-process performed on the post-processing portion, while the manipulation portion enters the new job setting. The input/output controller can select a post-process performed by a post-processing unit having the identification information stored in the storage portion.

### CROSS-REFERENCE TO RELATED APPLICATIONS

The disclosure of Japanese Patent Application No. 2019-123826, which was filed on Jul. 2, 2019, is incorporated herein by reference in its entirety.

### BACKGROUND

### Technological Field

The present disclosure relates to an image forming apparatus, an image forming method, and an image forming program.

### Description of the Related Art

Some image forming apparatuses allow a plurality of types of post-processing units to be attached replaceably. Patent Literature 1 discloses the technology concerning such an image forming apparatus. Patent Literature 1 describes an image forming apparatus configured to replaceably attach a die for punching and a die for creasing.

### CITATION LIST

### Patent Literature

Patent Literature 1: JP 2016-41623 A

### SUMMARY

However, a new job cannot be input to the above-described image forming apparatus allowing post-processing units to be attached replaceably if a post-processing unit used for the new job is not attached to the image forming apparatus.

A post-processing unit used for a new job may differ from a post-processing unit used for the preceding job in progress. Then, it may be necessary to wait until the preceding job is complete, replace the post-processing unit, and then input a new job. The time to input a new job may be comparable to downtime in which the image forming apparatus cannot operate.

It is an object of the present disclosure to provide an image forming apparatus, an image forming method, and an image forming program that may be capable of preventing an occurrence of downtime and improving the productivity in a configuration that enables replacement of a post-processing unit.

To achieve the abovementioned object, according to an aspect of the present disclosure, an image forming apparatus reflecting one aspect of the present disclosure may include: a post-processing portion replaceably mounted with a plurality of post-processing units that perform different post-processes on a recording medium where an image is formed; a manipulation portion to enter a new job setting including a selection of a post-process performed on the post-processing portion; and a controller to control the post-processing portion and the manipulation portion. The controller includes: a storage portion that stores identification information about a post-processing unit mountable on the post-processing portion; and an input/output controller that is capable of selecting a post-process performed on the post-processing portion while the manipulation portion enters the new job setting. The input/output controller may be capable of selecting a post-process performed by a post-processing unit having the identification information stored in the storage portion.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the present disclosure:

FIG. 1 is a schematic diagram illustrating an overall configuration of an image forming apparatus according to embodiments of the present disclosure;

FIG. 2 is a block diagram illustrating the image forming apparatus according to the embodiments of the present disclosure;

FIG. 3 is a functional configuration diagram illustrating a controller in the image forming apparatus according to the embodiments of the present disclosure;

FIG. 4 is a flowchart illustrating a registration process for post-processing units in an image forming method according to a first embodiment;

FIG. 5 is a diagram illustrating a registration screen for a post-processing unit to be displayed on a manipulation display portion in the image forming method according to the first embodiment;

FIG. 6 is a flowchart illustrating the image forming method according to the first embodiment;

FIG. 7 is a diagram illustrating a new job setup screen to be displayed in the image forming method according to the first embodiment;

FIG. 8 is a diagram illustrating an alarm screen to mount a post-processing unit to be displayed in the image forming method according to the first embodiment;

FIG. 9 is a flowchart illustrating the image forming method according to a second embodiment; and

FIG. 10 is a flowchart illustrating the image forming method according to a third embodiment.

### DETAILED DESCRIPTION OF EMBODIMENTS

Embodiments of the present disclosure will be described in further detail with reference to the accompanying drawings. However, the scope of the disclosure is not limited to the disclosed embodiments. Component elements common to the embodiments are given the same reference symbol and duplicate description is partially omitted.

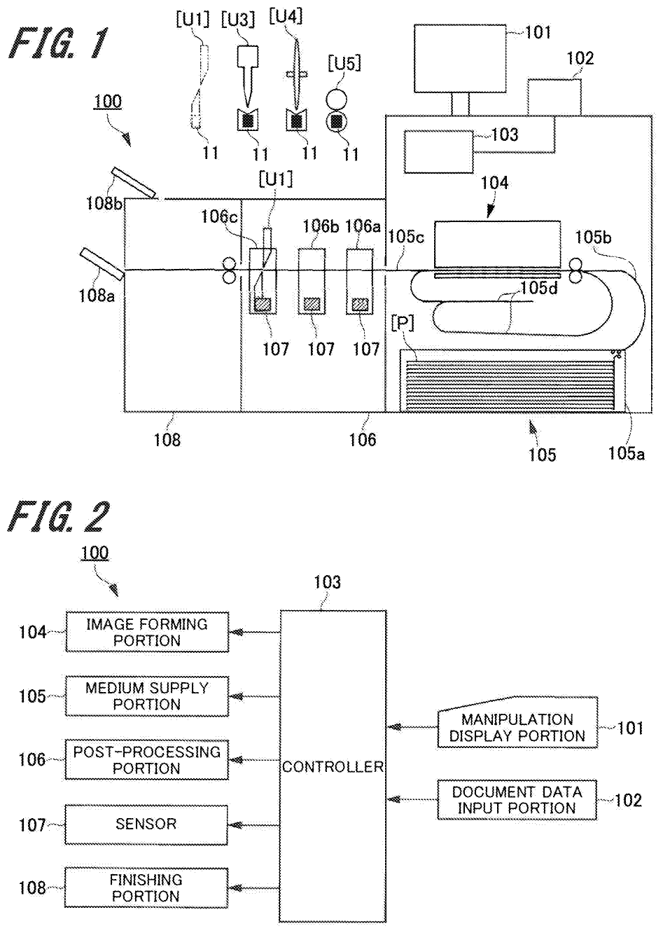

Schematic configuration of the image forming apparatus according to the embodiments FIG. 1 is a schematic diagram illustrating an overall configuration of an image forming apparatus 100 according to the embodiments of the present disclosure. FIG. 2 is a block diagram illustrating the image forming apparatus 100 according to the embodiments of the present disclosure. The image forming apparatus 100 illustrated in these diagrams has the function to print images on a sheet-like recording medium [P] and apply post-processing to the recording medium [P] where images are printed.

The image forming apparatus 100 includes a manipulation display portion 101, a document data input portion 102, a controller 103, an image forming portion 104, a medium supply portion 105, a post-processing portion 106, a sensor 107, and a finishing portion 108. These members are configured as follows.

Manipulation Display Portion 101

The manipulation display portion 101 includes a manipulation portion and a display portion. The manipulation portion inputs various types of setup information about the image forming apparatus 100 and setup information about a job performed on the image forming apparatus 100. The display portion displays images used for the manipulation. Various types of setup information about the image forming apparatus 100 include, for example, registration information about post-processing units [U1], [U3], and so on that can be mounted on the post-processing portion 106 to be described. The job setup information includes the number of copies printed by the image forming apparatus 100, the number of collocated images formed on a single recording medium [P], and the setting of post-processing applied to the recording medium [P] where an image is formed.

The manipulation display portion 101 includes a manipulation button and a display panel. The manipulation button may be provided as a touch panel provided integrally with the display panel. The manipulation display portion 101 may be provided as a personal computer connected to the image forming apparatus 100 or other external apparatuses.

The manipulation display portion 101 also functions as an alarm portion that provides a visual alarm. The manipulation display portion 101 displays an alarm prompting the replacement of a post-processing unit for the post-processing portion 106 to be described, for example. The alarm portion is not limited to the configuration of visually providing an alarm but may be provided as a speaker to audibly providing an alarm or may be provided as both.

Document Data Input Portion 102

The document data input portion 102 inputs image data received from a personal computer or other external apparatuses connected to the image forming apparatus 100, for example, and may be provided as an input/output interface. The document data input portion 102 may also be provided as a reader that reads a document rack and an image in a document placed on the document rack.

Controller 103

The controller 103 controls operations of the portions of the image forming apparatus 100 according to manipulations on the manipulation display portion 101 or signals received from an external apparatus such as a personal computer connected to the image forming apparatus 100 and is configured as a calculator. The calculator is provided as hardware used as a computer. The calculator includes a CPU (Central Processing Unit), ROM (Read Only Memory), and RAM (Random Access Memory). The calculator also includes non-volatile storage and a network interface.

The controller 103 provides specific control to perform the image forming method according to first through third embodiments to be described. The controller 103 controls the portions of the image forming apparatus 100 based on image forming programs loaded and saved into the RAM from the ROM or an external apparatus.

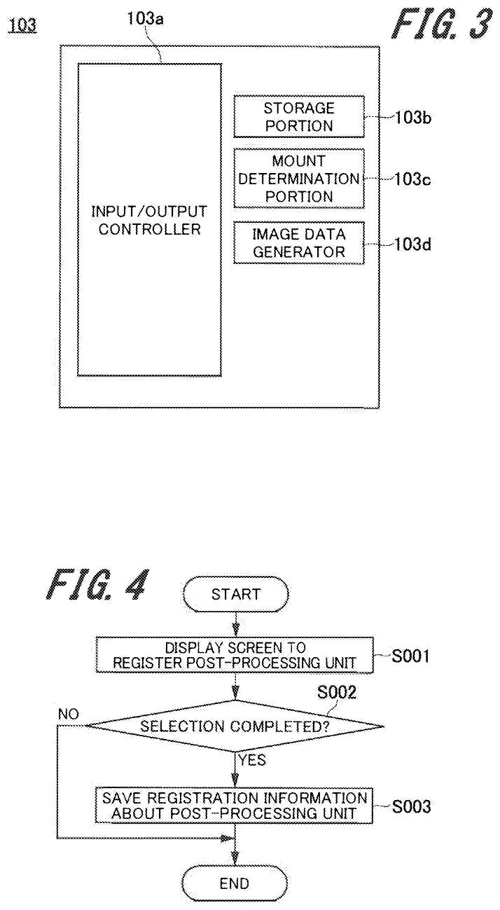

FIG. 3 is a functional configuration diagram illustrating the controller 103 in the image forming apparatus according to embodiments of the present disclosure. As illustrated in FIG. 3, the controller 103 includes an input/output controller 103a, a storage portion 103b, a mount determination portion 103c, and an image data generator 103d. Configurations of these portions will be described based on FIG. 3 with reference to FIGS. 1 and 2.

Input/Output Controller 103a

The input/output controller 103a is connected to the controller 103 and the other portions configuring the image forming apparatus 100 such as the manipulation display portion 101, the document data input portion 102, the image forming portion 104, the medium supply portion 105, the post-processing portion 106, the sensor 107, and the finishing portion 108. The input/output controller 103a controls driving of the image forming portion 104, the medium supply portion 105, the post-processing portion 106, and the finishing portion 108 based on inputs from the manipulation display portion 101, the document data input portion 102, and the external apparatus and image forming programs saved in the controller 103.

Storage Portion 103b

The storage portion 103b stores various types of setup information supplied from the manipulation display portion 101 or an external apparatus. Various types of setup information stored in the storage portion 103b include various types of setup information about the image forming apparatus 100 and setup information about jobs performed on the image forming apparatus 100.

As above, various types of setup information about the image forming apparatus 100 include, for example, registration information about post-processing units [U1], [U3], and so on that can be mounted on the post-processing portion 106 to be described. The job setup information includes the number of copies printed by the image forming apparatus 100, the number of collocated images formed on a single recording medium [P], and the setting of post-processing applied to the recording medium [P] where an image is formed.

The storage portion 103b maintains individual identification information about post-processing units [U1], [U3], and so on to be described.

Mount Determination Portion 103c

The mount determination portion 103c determines whether the post-processing portion 106 is mounted with appropriate post-processing units [U1], [U3], and so on, based on information transmitted from the sensor 107 to be described and the registration information about post-processing units [U1], [U3], and so on maintained in the storage portion 103b. The determination procedure performed by the mount determination portion 103c will be described in detail in the image forming method to be described.

Image Data Generator 103d

The image data generator 103d generates image data for printing by performing a job to rasterize document data for images formed on the recording medium [P]. The image data generator 103d may be provided as a raster image processor (RIP), for example Document data for images processed by the image data generator 103d is assumed to be images input from the document data input portion 102.

Image Forming Portion 104

Returning to FIGS. 1 and 2, the image forming portion 104 forms an image by printing on a principal surface of the sheet-like recording medium [P] according to instructions from the controller 103. The image forming portion 104 is not limited to use a specific image formation system but may use an electrophotographic system or an ink jet system, for example. For example, the image forming portion 104 based on the electrophotographic system includes a toner image formation unit, an intermediate transfer belt, and a fixing portion and forms a toner image on a principal surface of the recording medium [P]. The image forming portion 104 based on the ink jet system includes an ink-jet head and forms an ink image on a principal surface of the recording medium [P].

Medium Supply Portion 105

The medium supply portion 105 successively supplies the recording medium [P] to the image forming portion 104 and the post-processing portion 106 according to instructions from the controller 103. The medium supply portion 105 includes a medium container 105a to contain a large amount of the recording medium [P] and a medium supply path 105b to supply the image forming portion 104 with the recording medium [P] contained in the medium container 105a on a sheet basis. The medium supply portion 105 also includes a medium transport path 105c that transports the recording medium [P] having an image printed by the image forming portion 104 in the order of the post-processing portion 106 and the finishing portion 108.

The medium supply portion 105 moreover includes a medium reversing transport path 105d that reverses the recording medium [P] having an image printed by the image forming portion 104 while moving in the transport direction and re-supplies the recording medium [P] to the image forming portion 104. The image forming portion 104 can thereby print images on two principal surfaces, namely, the face and reverse side, of the recording medium [P].

Post-Processing Portion 106

The post-processing portion 106 applies post-processing to the recording medium [P] transported from the image forming portion 104 according to instructions from the controller 103. In particular, the post-processing portion 106 includes a plurality of (three as an example) unit retainers 106a through 106c. The unit retainers 106a through 106c are placed along the medium transport path 105c. The unit retainers 106a through 106c each detachably retain the post-processing units [U1], [U3], and so on and enable the retained post-processing units [U1], [U3], and so on to perform post-processing. The description below explains the post-processing units [U1], [U3], and so on that are detachably retained by the unit retainers 106a through 106c of the post-processing portion 106.

Post-Processing Unit

The post-processing units [U1], [U3], and so on may each represent a cutting process unit, a crease unit for creasing, a slit formation unit, a perforation formation unit, for example, and may be provided as individual units according to sizes. The post-processing units [U1], [U3], and so on are capable of post-processing operations on the recording medium [P] while mounted on the unit retainers 106a through 106c. As illustrated in the drawing, the unit retainer 106c retains only one post-processing unit [U1]. The other post-processing units [U3] and so on are detached from the unit retainers 106a through 106c.

The post-processing units [U1], [U3], and so on each include an identification information retainer 11 to identify each other. The identification information retainer 11 is provided as a wireless tag, for example, that stores individual identification information and transmits the stored individual identification information. The wireless tag may be provided as a passive tag not transmitting the individual identification information itself or as an active tag. The identification information retainer 11 is fastened to a specified position of each of the post-processing units [U1], [U3], and so on. The sensor 107 to be described reads the individual identification information retained in the identification information retainer 11.

Sensor 107

The sensor 107 reads the individual identification information from the identification information retainer 11 provided for the post-processing units [U1], [U3], and so on mounted on the post-processing portion 106. The sensor 107 is comparable to a wireless tag reader when the identification information retainer 11 is provided as a wireless tag. The sensor 107 is provided for each of the unit retainers 106a through 106c of the post-processing portion 106 and reads the individual identification information from the identification information retainer 11 for the post-processing units [U1], [U3], and so on attached to the unit retainers 106a through 106c. The read information is transmitted to the controller 103.

Finishing Portion 108

The finishing portion 108 applies a finishing process to the recording medium [P] transported from the post-processing portion 106 according to instructions from the controller 103. The finishing process is performed at the end of post-processing and is comparable to any one of the above-described post-processes or a different type of post-process. The finishing portion 108 performs one post-process as the finishing process. The finishing portion 108 successively ejects the finished recording medium [P] onto trays 108a and 108b.

Image Forming Method According to the First Embodiment

The description below explains the first embodiment of the image forming method implemented by the above-described image forming apparatus 100. As described below, the image forming method according to the first embodiment is achieved by allowing a CPU for functional portions configuring the controller 103 of the image forming apparatus 100 to perform processes based on an image processing program stored in the ROM or RAM.

Registration Process for Post-Processing Units

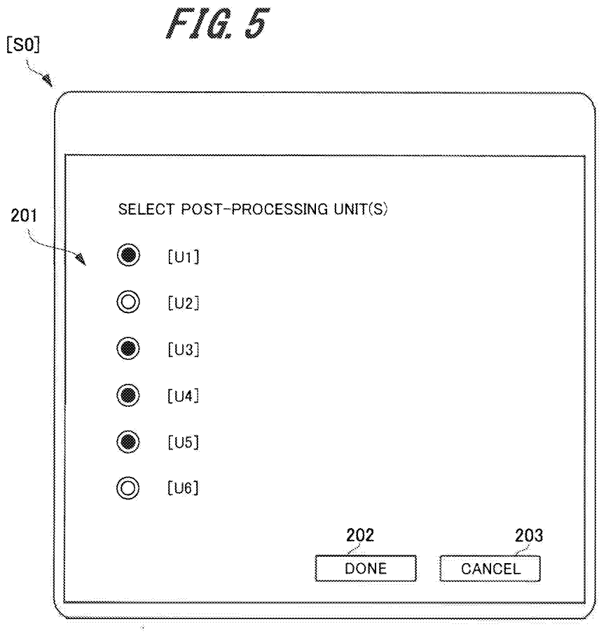

FIG. 4 is a flowchart illustrating a registration process for post-processing units in the image forming method according to the first embodiment. The description below explains steps of the registration process for post-processing units in the image forming method according to the first embodiment of the disclosure by following the flowchart in FIG. 4 with reference to FIGS. 1 through 3 as needed. The following process flow starts when the manipulation display portion 101 or an external apparatus inputs a request to register a post-processing unit.

Step S001

At step S001, the input/output controller 103a instructs the manipulation display portion 101 to display a registration screen for post-processing units. The manipulation display portion 101 then displays the registration screen for post-processing units. FIG. 5 is a diagram illustrating an example registration screen [S0] for post-processing units displayed by the image forming method according to the first embodiment of the present disclosure. The registration screen [S0] is used to register a post-processing unit that can be mounted on the image forming apparatus 100.

The registration screen [S0] for post-processing units displays a selection screen 201 for post-processing units, a completion button 202, and a cancellation button 203. The selection screen 201 for post-processing units displays all post-processing units [U1] through [U6] attachable to and detachable from the unit retainers 106a through 106c of the image forming apparatus 100 and can select one or more of the post-processing units.

Using the selection screen 201, for example, an operator can select a post-processing unit that is owned by the operator and can be practically mounted on the image forming apparatus 100 to perform jobs. The example in FIG. 5 displays six attachable and detachable post-processing units [U1] through [U6] and selects the post-processing units [U1], [U3], [U4], and [U5].

Manipulation on the completion button 202 completes the selection of a post-processing unit on the registration screen [S0]. Manipulation on the cancellation button 203 cancels the selection of a post-processing unit on the registration screen [S0].

A post-processing unit displayed on the registration screen [S0] may be input from the manipulation display portion 101 or an external apparatus. It may be possible to additionally enter and display another post-processing unit in addition to the post-processing units [U1] through [U6].

Step S002

At step S002, the input/output controller 103a determines whether the selection of post-processing units is complete. The input/output controller 103a determines that the selection is complete (YES) when the completion button 202 is manipulated on the registration screen [S0], and then proceeds to step S003. The input/output controller 103a determines that the selection is incomplete (NO) when the cancellation button 203 is manipulated on the registration screen [S0] and terminates the registration process by assuming the process to be canceled.

Step S003

At step S003, the input/output controller 103a allows the storage portion 103b to store the post-processing unit selected on the registration screen [S0] as registration information about the post-processing unit. For example, the individual identification information about the post-processing units [U1], [U3], [U4], and [U5] is stored as the post-processing units that can be mounted on the post-processing portion 106 while a job is performed.

The individual identification information stored herein may be comparable to the identification information retained in the identification information retainer 11 provided for each of the post-processing units [U1], [U3], [U4], and [U5]. The individual identification information ready by the sensor 107 may be additionally stored in the storage portion 103b.

Performing a Job

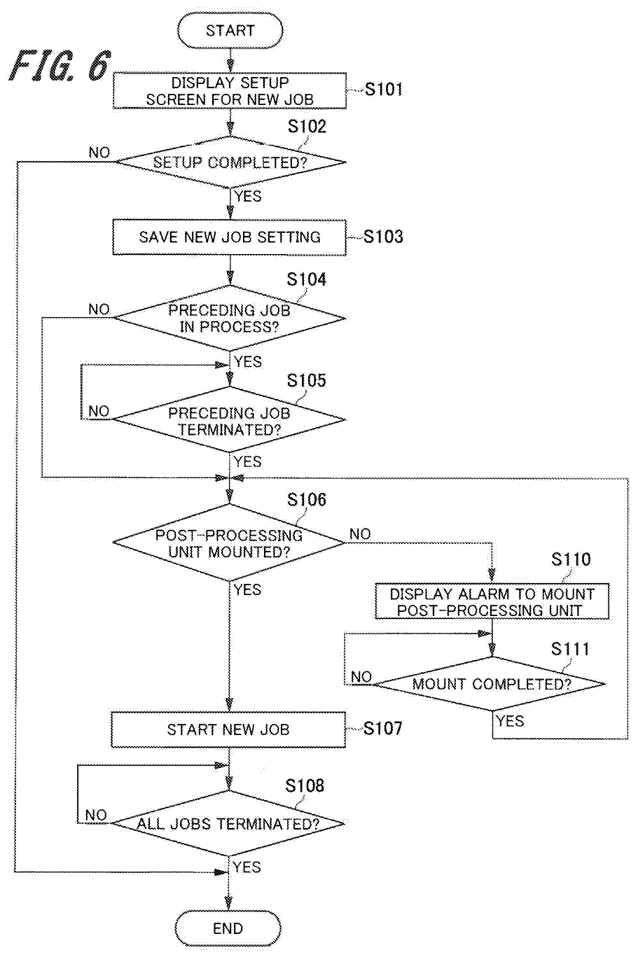

FIG. 6 is a flowchart illustrating the image forming method according to the first embodiment to illustrate a procedure to perform a job. The description below explains the procedure to perform a job by following the flowchart in FIG. 6 with reference to FIGS. 1 through 3. The following process flow starts when the manipulation display portion 101 or an external apparatus inputs a request to set up a new job.

Step S101

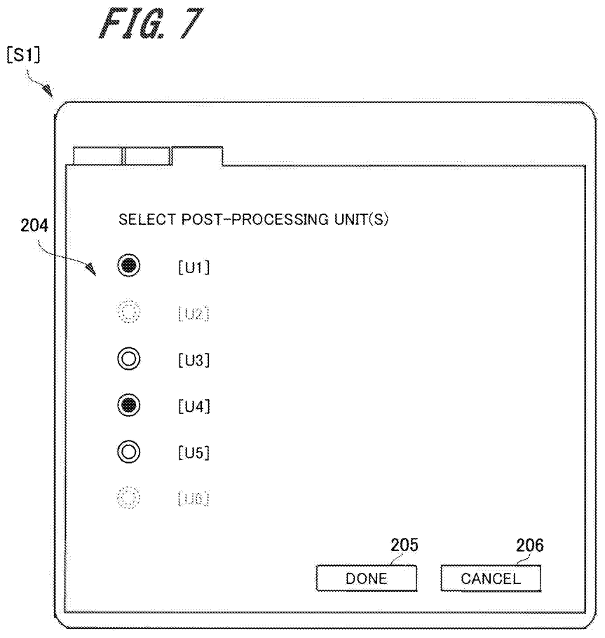

At step S101, the input/output controller 103a instructs the manipulation display portion 101 to display a new job setup screen. The manipulation display portion 101 then displays the new job setup screen. FIG. 7 is a diagram illustrating an example new job setup screen [S1] displayed based on the image forming method according to the first embodiment and illustrates the screen to select post-processes among processing items performed by the new job.

The new job setup screen [S1] displays a post-process selection screen 204, a completion button 205, and a cancellation button 206. The post-process selection screen 204 displays all post-processes performable on the image forming apparatus 100 and enables the selection of one or more post-processes. The performable post-process signifies a post-process performed by the post-processing unit whose individual identification information is stored in the storage portion 103b. The maximum number of post-processes selectable on the selection screen 204 corresponds to the number of the unit retainers 106a through 106c provided for the post-processing portion 106 of the image forming apparatus 100.

By using the selection screen 204, an operator can select a post-processing unit usable for the new job. The example in FIG. 7 shows that selectable post-processing units correspond to the post-processing units [U1], [U3], [U4], and [U5] whose individual identification information is stored in the storage portion 103b and that the post-processing units [U1] and [U4] are selected. As illustrated in the drawing, the selection screen 204 may display the unregistered post-processing units [U2] and [U6] to disable the selection manipulation.

The setup screen [S1] allows manipulation of the completion button 205 to complete the new job setup. The setup screen [S1] allows manipulation of the cancellation button 206 to cancel the process to set up a new job or cancel a new job. The new job setup screen [S1] can selectively display a screen to set up other processing items in addition to the post-process selection screen 204. Manipulation of the completion button 205 can complete the setup of all processing items concerning the new job.

Step S102

At step S102, the input/output controller 103a determines whether the new job setup is complete. The input/output controller 103a determines that the setup is complete (YES) when the completion button 205 is manipulated on the setup screen [S1], and then proceeds to step S103. The input/output controller 103a determines that the job setup is incomplete (NO) when the cancellation button 206 is manipulated on the setup screen [S1], and then terminates the process.

Step S103

At step S103, the input/output controller 103a allows the storage portion 103b to store the new job setup information such as the post-process and other settings concerning the new job selected on the setup screen [S1].

Step S104

At step S104, the input/output controller 103a determines whether the image forming apparatus 100 currently performs a preceding job. Control proceeds to step S105 if it is determined that a preceding job is performed (YES). Control proceeds to step S106 if it is determined that a preceding job is not performed (NO).

Step S105

At step S105, the input/output controller 103a determines whether the image forming apparatus 100 currently terminates the preceding job. The determination is repeated until it is determined that the preceding job is terminated (YES). Control proceeds to step S106 if it is determined that the preceding job is terminated (YES).

Step S106

At step S106, the mount determination portion 103c determines whether the post-processing unit is mounted. The state of the post-processing unit being mounted herein signifies that all the post-processing units [U1] and [U4] selected during the new job setup are mounted on the unit retainers 106a through 106c of the post-processing portion 106.

The mount determination portion 103c performs the determination based on the individual identification information on the unit retainers 106a through 106c transmitted from the sensor 107 and the new job setup information stored in the storage portion 103b. The mount determination portion 103c determines that the post-processing units are mounted (YES) if there is a complete match between the individual identification information transmitted from the sensor 107 and the individual identification information on the post-processing units indicated in the new job setup information saved in the storage portion 103b. Control proceeds to step S107 if it is determined that the post-processing units are mounted. Otherwise, it is determined that post-processing unit is not mounted (NO). Control proceeds to step S110.

Step S107

At step S107, the input/output controller 103a starts the new job whose setup is saved at step S103. The image data generator 103d thereby generates image data for printing based on an image input from the document data input portion 102. The medium supply portion 105 starts supplying the recording medium [P] to the image forming portion 104. The image forming portion 104 further starts printing the image on the recording medium [P] supplied from the medium supply portion 105 based on the image data generated by the image data generator 103d. The post-processing portion 106 starts post-processing on the recording medium [P] where the image is formed by the image forming portion 104. The finishing portion 108 starts a finishing process on the post-processed recording medium [P].

Step S108

At step S108, the input/output controller 103a determines whether to terminate all the new jobs whose settings are saved at step S103. The process is repeated until it is determined that all the new jobs are terminated (YES). The input/output controller 103a terminates the sequence of processes concerning new jobs if it is determined that all the new jobs are terminated (YES).

Step S110

Control proceeds to step S110 if it is determined that a post-processing unit is not mounted (NO) at step S106. At step S110, the input/output controller 103a instructs the manipulation display portion 101 to display an alarm prompting to mount a post-processing unit. The manipulation display portion 101 thereby displays the alarm prompting to mount a post-processing unit.

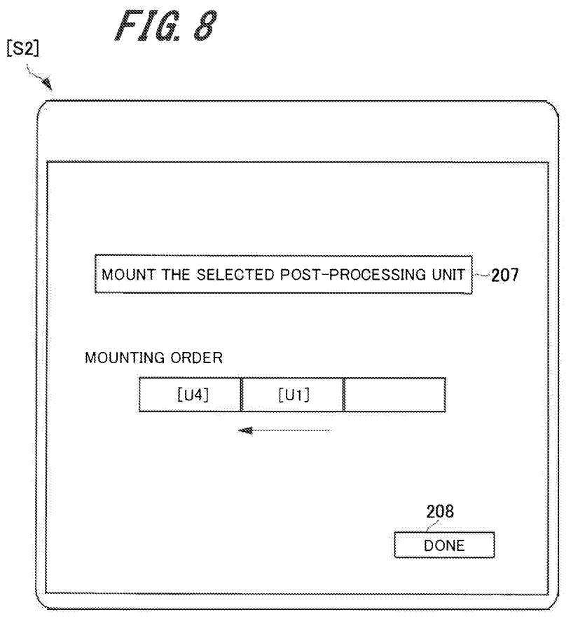

FIG. 8 is a diagram illustrating an alarm screen to mount a post-processing unit to be displayed in the image forming method according to the first embodiment. An alarm screen [S2] displays an alarm display screen 207 and a completion button 208. The alarm display screen 207 shows a message prompting to mount a post-processing unit. The alarm display screen 207 may display the post-processing units [U1] and [U4] to be mounted on the unit retainers 106a through 106c of the post-processing portion 106 and mounting states of the post-processing units [U1] and [U4]. The mounting state may signify the order of mounting the post-processing units [U1] and [U4] in the direction of transporting the recording medium [P] or the specification of the unit retainers 106a through 106c to be mounted. An arrow in FIG. 8 indicates the direction of transporting the recording medium [P] to represent the order of mounting the post-processing units [U1] and [U4] along the arrow.

The alarm screen [S2] enables the manipulation of the completion button 208 to submit the completion of mounting the post-processing unit.

Step S111

At step S111, the input/output controller 103a determines whether the setting to mount the post-processing unit is complete. The input/output controller 103a determines that the setting is complete (YES) when the completion button 208 is manipulated on the alarm screen [S2]. The process is repeated until it is determined that the setting is complete (YES). Control proceeds to S106 if it is determined that the setting is complete (YES). The subsequent steps are performed.

### Effects of the First Embodiment

According to the first embodiment as above, the storage portion 103b stores the individual identification information about the post-processing units [U1], [U3], [U4], and [U5] mountable on the post-processing portion 106. It is possible to enter a new job setting from the manipulation display portion 101 if a post-processing unit to be used for a new job to be performed next can be mounted on the post-processing portion 106 though not mounted currently.

For example, even when the preceding job performs a different post-process, it is possible to enter the new job setting including the post-processing from the manipulation display portion 101 without waiting for the preceding job to terminate, namely, even during execution of the preceding job. As a result, a new job can be performed immediately after the replacement of a processing unit on completion of the preceding job. It is possible to improve the productivity of the image forming apparatus 100 without causing downtime.

Image Forming Method According to the Second Embodiment

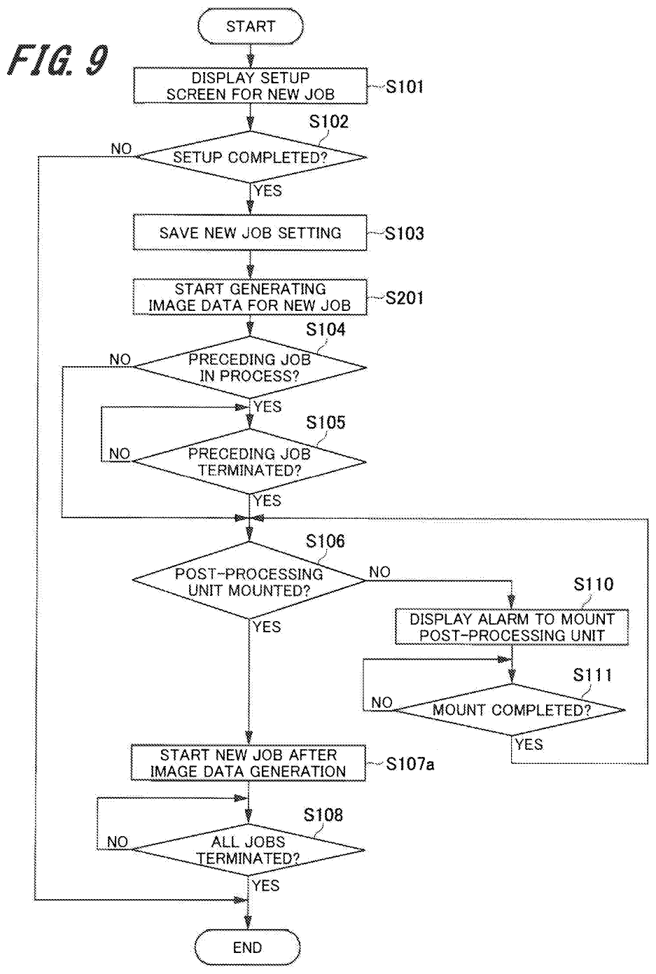

The description below explains the second embodiment of the image forming method provided by the image forming apparatus 100. FIG. 9 is a flowchart illustrating the image forming method according to the second embodiment to represent a procedure to perform a job. The flowchart in FIG. 9 differs from the flowchart in FIG. 6 according to the first embodiment in the addition of step S201 between steps S103 and S104. The addition of step S201 changes the contents of the process at step S107a following step S106. The other steps are equal to those described in the first embodiment. The description below explains only step S201 added to perform a job and step S107a subject to a change in the process contents.

Performing a Job

Step S201

At step S201, the input/output controller 103a instructs the image data generator 103d to generate image data. The image data generator 103d starts generating image data for printing based on the image input from the document data input portion 102 according to the new job whose setting is saved at the immediately preceding step S103.

Step S107a

At step S107a following step S106, the input/output controller 103a starts the process after the image data generation in the new job whose setting is saved at the immediately preceding step S103. Namely, the medium supply portion 105 starts supplying the recording medium [P] to the image forming portion 104. The image forming portion 104 starts printing an image on the recording medium [P] supplied from the medium supply portion 105 based on the image data generated at step S201. The post-processing portion 106 starts post-processing the recording medium [P] where the image is formed by the image forming portion 104. The finishing portion 108 starts a finishing process on the post-processed recording medium [P].

### Effects of the Second Embodiment

As above, the second embodiment starts generating image data after saving settings for a new job (step S103). It is possible to perform a process to generate image data for the new job in parallel with the subsequent determination process. This can provide an effect of shortening the time to perform a new job in addition to the effect of the first embodiment.

Image Forming Method According to the Third Embodiment

The description below explains the third embodiment of the image forming method provided by the image forming apparatus 100.

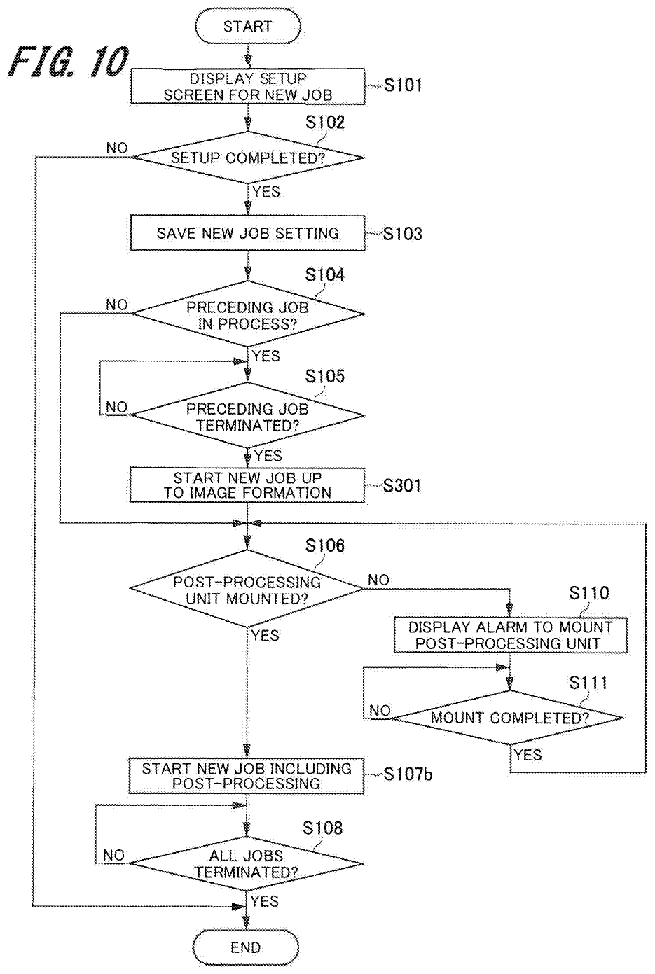

FIG. 10 is a flowchart illustrating the image forming method according to the third embodiment to represent a procedure to perform a job. The flowchart in FIG. 10 differs from the flowchart in FIG. 6 according to the first embodiment in the addition of step S301 between steps S105 and S106. The addition of step S301 changes the contents of the process at step S107b following step S106. The other steps are equal to those described in the first embodiment. The description below explains only step S301 added to perform a job and step S107b subject to a change in the process contents.

Performing a Job

Step S301

At step S301, the input/output controller 103a starts a process up to the image formation in the new job whose setting is saved at step S103. The image data generator 103d thereby generates image data for printing based on the image input from the document data input portion 102. The medium supply portion 105 starts supplying the recording medium [P] to the image forming portion 104. The image forming portion 104 starts printing an image on the recording medium [P] supplied from the medium supply portion 105 based on the image data generated by the image data generator 103d.

Step S107b

At step S107b following step S106, the input/output controller 103a starts the process after the image formation in the new job whose setting is saved at step S103. The post-processing portion 106 starts post-processing the recording medium [P] where the image is formed by the image forming portion 104. The finishing portion 108 starts a finishing process on the post-processed recording medium [P].

### Effects of the Third Embodiment

As above, the third embodiment starts the process up to the image formation in the new job after it is determined that the preceding job terminates (step S105). The job can proceed to the image formation while a post-processing unit is replaced even if the post-processing portion 106 is not mounted with the post-processing unit to be used to perform the new job. There is provided an effect of shortening the time to perform a new job in addition to the effect of the first embodiment. The third embodiment can be combined with the second embodiment, making it possible to further shorten the time required for a new job.

As used herein, the words “can” and “may” are used in a permissive (i.e., meaning having the potential to), rather than mandatory sense (i.e., meaning must). The words “include,” “includes,” “including,” and the like mean including, but not limited to. Similarly, the singular form of “a” and “the” include plural references unless the context clearly dictates otherwise. And the term “number” shall mean one or an integer greater than one (i.e., a plurality).

### REFERENCE SIGNS LIST

100 . . . image forming apparatus
101 manipulation display portion (manipulation portion) (alarm portion)
103 . . . controller
103b . . . storage portion
103a . . . input/output controller
104 . . . image forming portion
103d . . . image data generator
106 . . . post-processing portion
107 . . . sensor
[P] . . . recording medium
[U1] through [U6] . . . post-processing unit

What is claimed is:

1. An image forming apparatus, comprising:
a post-processing portion replaceably mounted with a plurality of post-processing units that perform different post-processes on a recording medium where an image is formed;
a manipulation portion configured to enter a new job setting including a selection of a post-process performed on the post-processing portion; and
a controller configured to control the post-processing portion and the manipulation portion, wherein the controller includes:
a storage portion that stores identification information about a post-processing unit mountable on the post-processing portion; and
an input/output controller that is capable of selecting a post-process performed on the post-processing portion, while the manipulation portion enters the new job setting, and
wherein the input/output controller is capable of selecting a post-process performed by a post-processing unit having the identification information stored in the storage portion.

2. The image forming apparatus according to claim 1, further comprising:
a sensor that detects identification information about a post-processing unit mounted on the post-processing portion,
wherein the input/output controller starts the new job based on identification information detected by the sensor and the new job setting entered from the manipulation portion, when the post-processing portion is determined to be mounted with a post-processing unit to perform the selected post-process.

3. The image forming apparatus according to claim 2, further comprising:
an alarm portion that generates an alarm prompting a post-processing unit to be replaced on the post-processing portion,
wherein the input/output controller allows the alarm portion to generate the alarm based on identification information detected by the sensor and the new job setting entered from the manipulation portion when the post-processing portion is determined to be not mounted with a post-processing unit to perform the selected post-process.

4. The image forming apparatus according to claim 3, wherein the alarm portion (i) provides a display portion and (ii) displays a state of mounting a post-processing unit to perform the selected post-process on the post-processing portion.

5. The image forming apparatus according to claim 1, further comprising:
an image forming portion configured to form an image on the recording medium; and
an image data generator configured to generate image data for an image formed by the image forming portion,
wherein, when a setting of the new job is entered from the manipulation portion, the input/output controller allows the image data generator to generate the image data based on the new job; and
wherein, when the new job is entered from the manipulation portion and the image forming portion and the post-processing portion are performing a preceding job, the input/output controller starts the new job subsequent to the generation of image data after the preceding job terminates.

6. The image forming apparatus according to claim 1, further comprising:
an image forming portion configured to form an image on the recording medium; and
a sensor that detects identification information about a post-processing unit mounted on the post-processing portion,
wherein, when (i) a setting of the new job is entered from the manipulation portion and (ii) the image forming portion and the post-processing portion are performing a preceding job, the input/output controller allows the image forming portion to start forming an image based on the new job setting after the preceding job terminates; and
wherein the input/output controller subsequently starts the new job subsequent to the image formation based on identification information detected by the sensor and the new job setting entered from the manipulation portion, when the post-processing portion is determined to be mounted with a post-processing unit to perform the selected post-process.

7. An image forming method provided by an image forming apparatus including (i) a post-processing portion replaceably mounted with a plurality of post-processing units that perform different post-processes on a recording medium where an image is formed and (ii) a manipulation portion configured to enter a new job setting including a selection of a post-process performed on the post-processing portion, the method comprising:
allowing a storage portion to store identification information about a post-processing unit mountable on the post-processing portion; and
enabling selection of a post-process performed by a post-processing unit having the identification information stored in the storage portion, while the manipulation portion enters the new job setting.

8. A non-transitory computer readable recording medium storing an image forming program executed by a controller of an image forming apparatus that includes (i) a post-processing portion replaceably mounted with a plurality of post-processing units that perform different post-processes on a recording medium where an image is formed and (ii) a manipulation portion configured to enter a new job setting including a selection of a post-process performed on the post-processing portion, the program causing a computer to perform:
allowing a storage portion to store identification information about a post-processing unit mountable on the post-processing portion; and
enabling selection of a post-process performed by a post-processing unit having the identification information stored in the storage portion, while the manipulation portion enters the new job setting.
